(19) United States
(12) Patent Application Publication
(10) Pub. No.: US 2003/0152211 A1
(43) Pub. Date: Aug. 14, 2003

(54) Selecting a numbering plan with the use of indicators

(76) Inventors: Andrei Krüger, (US); Sami Uskela, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/312,331

(22) PCT Filed: Jun. 25, 2001
(86) PCT No.: PCT/FI01/00605

(30) Foreign Application Priority Data
Jun. 27, 2000 (FI) 20001523

(51) Int. Cl. H04M 7/00

(52) U.S. Cl. 379/221.02

(57) ABSTRACT

In order to indicate a numbering plan to be used, an indicator is defined, by which a subscriber can indicate whether the subscriber's home numbering plan (203) or a serving network numbering plan (206) is used when routing a call. The indicator preferably indicates the use of the home numbering plan, in which case a telephone number without an indicator uses the serving network numbering plan.

### BACKGROUND OF THE INVENTION

The invention relates to routing of mobile station calls, and particularly to the selection of a numbering plan used in call routing in a visited network.

Mobile communication systems have been developed to free people from fixed telephone terminals without hindering their reachability. Along with the mobile communication systems, a variety of services provided by these systems have also developed. At the moment, various new forms of services are being planned for the current and especially for the future, so-called third generation mobile communication systems, such as the Universal Mobile Telecommunication System (UMTS). One of these service forms is a private numbering plan VPN (Virtual Private Network) enabling the use of one's own numbers. The VPN is one of the services representing a subscriber's personal numbering plan in the home network. In the following, the term “home numbering plan” is used to refer to these various subscriber numbering plans in the home network.

It is also typical of mobile communication systems that a subscriber can roam from the home network to a network of another operator, i.e. to a visited network. The aim of the third generation mobile communication systems is that the subscriber would be provided with the same services both in the visited network and in the home network. Thus, the subscriber should be able to use both a local numbering plan and a home numbering plan in the visited network. The problem is that the visited network numbering plan and the home numbering plan may overlap. In addition, only the home network is aware of the home numbering plan and the visited network of the local numbers.

One solution is to make the subscriber use an international numbering in cases where he wants to use the home numbering plan in the visited network. The problem of this solution is, however, that the advantages of the home numbering plan, e.g. shorter numbers and/or lower call prices, are no longer available.

### BRIEF DESCRIPTION OF THE INVENTION

It is thus an object of the invention to provide a method and an apparatus for implementing the method to solve the above problems. The objects of the invention are achieved by methods, systems, network nodes and user equipment, which are characterized in what is said in the independent claims. The preferred embodiments of the invention are disclosed in the dependent claims.

The invention is based on the idea that an indicator is defined, by which a subscriber can indicate whether he wants to use a home numbering plan or a serving network numbering plan. The indicator can be defined to refer to the home numbering plan, and when the indicator is missing, it means that the serving network numbering plan is taken into use. It is also possible to define the indicator to refer to the serving network numbering plan, and when it is missing, it means that the home numbering plan is taken into use. The home numbering plan contains various subscriber's personal or group-specific numbering plans in the subscriber home network. If the subscriber does not have a numbering plan of his own, the home numbering plan refers to the numbering plan that is generally used in the home network. The home numbering plan can also be a combination of a numbering plan specified for the subscriber and a numbering plan that is generally used in the home network. The serving network refers to a network, in whose area the subscriber is and through which the subscriber has access to the system. For example, the indicator can be a prefix preceding the telephone number, information after the telephone number or the message itself, where the telephone is transmitted.

An advantage of the invention is that it provides a simple way to indicate to the network, which numbering plan the subscriber wants to use in his call. Thus the advantages of the home numbering plan are also available when making a call from the visited network and local numbers can be used in the short form in the area of the visited network. In the embodiments, in which the indicator is a prefix indicating a home numbering plan, an advantage of the invention is also its backward compatibility: all current numbering plans function as before.

### BRIEF DESCRIPTION OF THE DRAWINGS

The invention will now be described in greater detail in connection with the preferred embodiments, with reference to the attached drawings, in which

FIG. 1 is a simplified block diagram of the 3GPP All IP system;

FIG. 2 is a flow chart of CSCF operation in a first preferred embodiment of the invention;

FIG. 3 is a flow chart of user equipment operation in a third preferred embodiment of the invention; and

FIG. 4 is a flow chart of the CSCF operation in the third preferred embodiment of the invention.

### DETAILED DESCRIPTION OF THE INVENTION

The present invention can be applied to any telecommunication system, in which a subscriber can roam to a visited network and use his home network subscription there. Such systems include so-called third generation mobile communication systems, such as the Universal Mobile Telecommunications System (UMTS) and the IS-41, and the pan-European GSM system (Global System for Mobile Communications) and the corresponding mobile communication systems, such as the DCS 1800 (Digital Cellular System for 1800 MHz) and the PCS (Personal Communication System) and systems based on the aforementioned systems, such as GSM 2+systems. In the following the invention will be described using the 3GPP All-IP system, i.e. an UMTS system based on IP technology (Internet Protocol technology) and specified in the 3GPP (3^{rd} generation partnership project), as an example without restricting the invention thereto. The specifications of mobile communication systems, and those of the third generation mobile communication systems in particular, are advancing rapidly; consequently, the invention may require additional changes. All words and expressions should therefore be interpreted broadly since they are only intended to illustrate, not to restrict, the invention.

The 3GGP All-IP system is based on a GPRS service of the pan-European GSM system and the intelligent network service implementation according to the CAMEL (Customised Applications for Mobile network Enhanced Logic) architecture. The GPRS and the CAMEL are GSM 2+phase services.

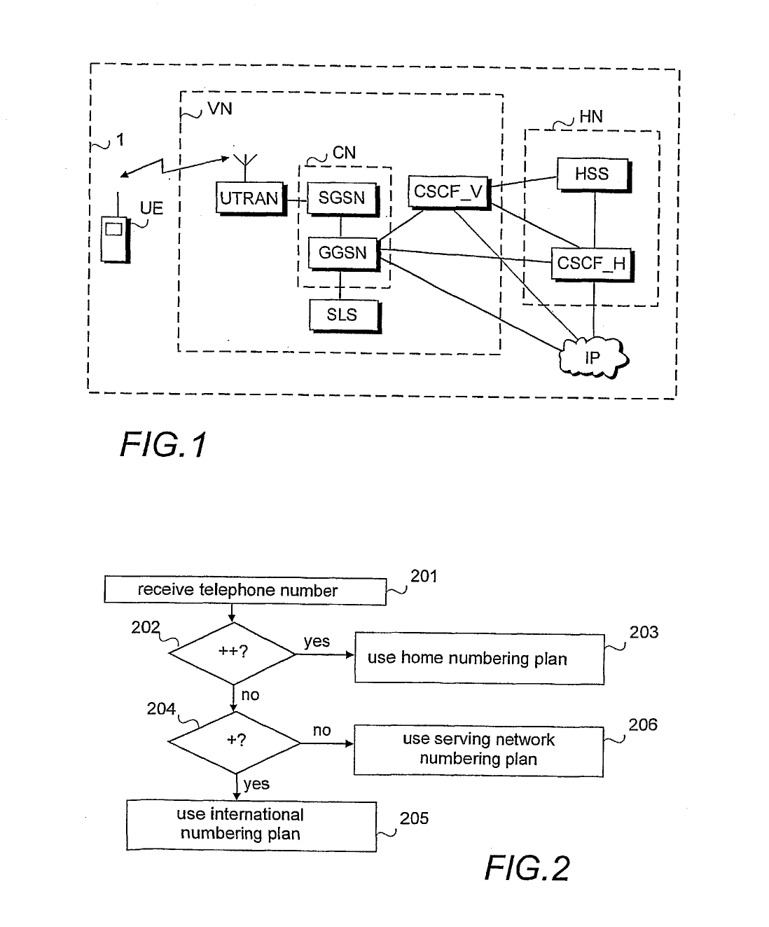

FIG. 1 shows a simplified network architecture, only describing elements of a telecommunication system 1 that are essential in understanding the invention. For the sake of clarity, it is assumed in FIG. 1 that the serving network is a visited network, not a home network. The network nodes illustrated in FIG. 1 are logical units, the implementation of which may differ from what is described. It is obvious to a person skilled in the art that both the visited network VN and the home network HN have a similar structure, although they contain different elements in FIG. 1. It is also obvious to a person skilled in the art that the system 1 may also comprise other functions and structures which need not be described in greater detail here.

A call state control function CSCF controls call establishment, is responsible for routing and contains e.g. a function corresponding to a switching function of the intelligent network service. The CSCF provides control of end-to-end IP telephony services. Signalling associated with the IP telephony, such as H.323 and SIP, terminates at user equipment UE and the CSCF. In other words, the CSCF is the network node in which IP telephony user equipment are registered and through which the signalling is transferred to the actual IP network IP, for example. The CSCF comprises IP telephony call state models, which are used for controlling call establishment with other network nodes, such as the service control point and IP telephony application servers (not shown in FIG. 1). The CSCF comprises a subscriber database, which logically corresponds to a visitor location register in the GSM system. The CSCF is also responsible for producing billing information. In the example of FIG. 1, the CSCF_H is a CSCF in the home network HN and the CSCF_V is a CSCF in the visited network VN. The CSCF operation according to the invention is explained in greater detail in connection with FIGS. 2 and 4.

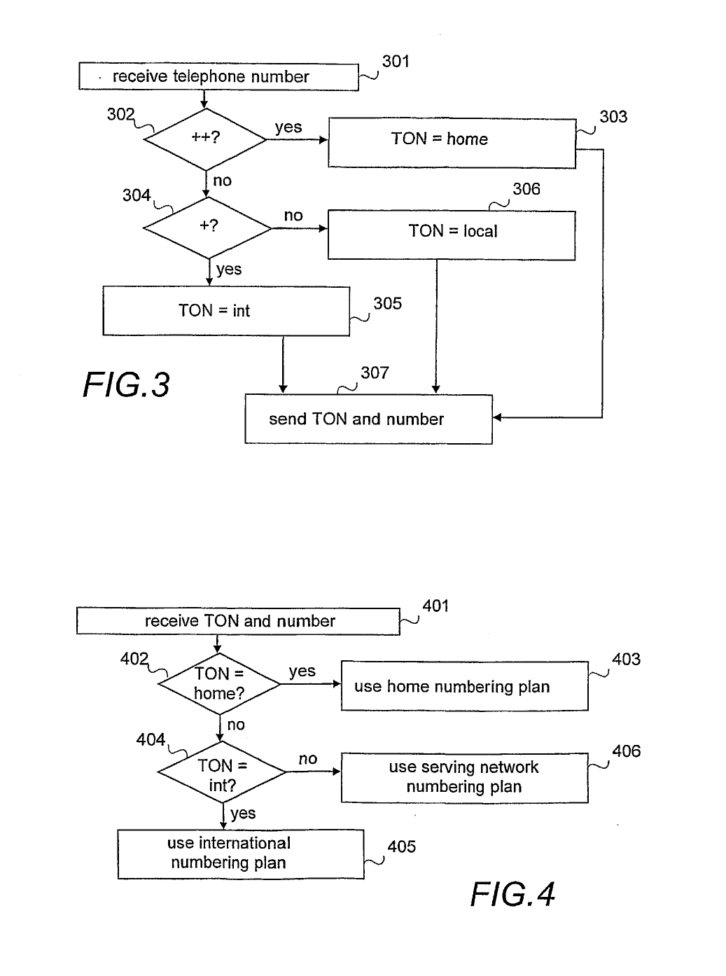

The user equipment UE comprises an actual terminal and an identification card USIM, also called a subscriber identification unit, detachably connected thereto. In this connection, the user equipment UE generally refers to a unity comprising the actual terminal and the subscriber identification unit. The subscriber identification unit USIM is a smart card which comprises subscriber identity and which performs authentication algorithms and stores authentication and cipher keys and subscription information necessary for the user equipment. A home network CSCF_H address, for example, may be stored in the subscriber identification unit USIM. The actual terminal can be any equipment capable of communicating in a mobile communication system. The terminal can thus be a simple terminal intended only for speech, or it can be a terminal for various services, operating as a service platform and supporting loading and carrying out different service-related functions. The terminal can also be a combination of various devices, for example a multimedia computer with a Nokia card phone connected thereto to provide a mobile connection. The user equipment operation according to a third and a fourth preferred embodiment of the invention is explained in greater detail in connection with FIG. 3.

In the example of FIG. 1, the visited network VN also comprises a core network CN and a UMTS terrestrial radio access network UTRAN and a service look-up server SLS. The home network HN also comprises the corresponding parts, but they are not shown in FIG. 1.

The UTRAN is formed of a group of radio network subsystems (not shown in FIG. 1), which are connected to a core network CN. The core network CN can be connected to external networks, such as IP networks IP. In the example of FIG. 1, the core network CN comprises a serving GPRS (General Packet Radio Service) support node SGSN serving the user equipment UE in its service area and a gateway GPRS support node GGSN connecting the operator to the external systems of the GPRS network, such as to the IP network IP. The GGSN functions as a router between the external address and the internal routing information (e.g. SGSN). Other types of core networks, such as IS-41, may comprise other network elements.

The support nodes SGSN and GGSN are usually interconnected by a backbone network (not shown in the figure). It is to be noted that the SGSN and GGSN functionalities can also be physically connected to the same network node, in which case the backbone network of the operator is not required. Logically, however, the nodes are different nodes. The IP telephony is in practice invisible to the elements of the core network. For the support nodes SGSN and GGSN, the IP telephony is only a PDP context with certain service quality requirements. The signalling associated with the IP telephony terminates at the user equipment and the CSCF, so there is no need for the SGSN or GGSN to understand it, and thus they do not participate in call routing.

In the example of FIG. 1, a service look-up server SLS is connected to the GGSN. The SLS preferably comprises a visited network CSCF_V address. The SLS may also comprise the alarm numbers and/or free service numbers of the visited network and other specific information relating to the visited network, and the user equipment can request for this information after the attachment to the GPRS network. Using the help of the SLS, for example, the user equipment UE can find out the visited network CSCF_V address. The user equipment UE can find the SLS by broadcasting an inquiry to which the SLS replies. The user equipment UE obtains the address from the reply, and it may request from the SLS for further information. The SLS address can also be obtained from the SGSN or GGSN also during the GPRS attachment procedure or immediately after it.

A home subscriber server HSS is a core network element, which is illustrated only in the home network HN in the example of FIG. 1. The home subscriber server HSS logically corresponds to the home location register in the GSM system, and subscriber data for each subscriber of the home network are stored therein permanently or semi-permanently such that the subscriber data are combined with a subscriber identifier, which, for example, is an IMSI in the GSM system. Subscriber data may for example contain the home network CSCF_H address, which can be transferred to the visited network CSCF_V during the registration.

IP telephony is a general term which covers services from the standard voice telephony VoIP (Voice over IP) to multimedia applications using IP data, voice and video in the IP telephony. In addition to the IP telephony, the above system supports other applications, such as the access to the Internet or an intranet. Correspondingly, an IP call refers to a call which utilizes IP-based user data flow and signalling. The user data may comprise various components, such as voice, video image and data. In addition to calls, the IP telephony may comprise call-like services, which can be unidirectional, directed to a group (or groups) or broadcast in a given area, for example.

In addition to prior art means, the system and its network nodes implementing the functionality of the present invention comprise means for implementing functions described in greater detail in connection with FIGS. 2, 3 and 4. More specifically, they comprise means for identifying a possible indicator in a telephone number and for call routing according to a numbering plan indicated by the indicator or the missing of the indicator. The existing network nodes comprise processors and memory that can be utilized in the functions of the invention. All changes necessary for implementing the invention can be carried out as additional or updated software routines and/or by application circuits (ASIC).

The invention is described in FIGS. 2, 3 and 4, assuming that an indicator is a prefix and that call, whose telephone number begins with a prefix ++, is routed according to a home numbering plan and a number without a prefix is routed according to a serving network numbering plan. The invention is not restricted to the prefix ++ in any way, but other indicators can be used as well. Thus, in the examples of FIGS. 2, 3 and 4 there are three different numbering plans available for the subscriber:

++NNN is a home numbering plan

+NNN is an international network numbering plan

NNN is a serving network numbering plan.

FIG. 2 shows the operation of a CSCF controlling the call, when a call utilizing IP telephony is made from user equipment UE. For the sake of clarity it is assumed that the user equipment has made itself known to the access network by performing a GPRS attach operation. In the GPRS attach procedure, the SGSN creates a mobility management context (MM context) and a logical link LLC (Logical Link Control) is provided between a mobile station MS and a SGSN node in the protocol layer. For the sake of clarity it is further assumed that the user equipment has activated a PDP context, i.e. a packet data address it wishes to use. The PDP context specifies different data transfer parameters, such as a PDP type (X.25 or IP, for example), a PDP address (IP address, for example), quality of service QoS and an NSAPI (Network Service Access Point Identifier). Furthermore, it is assumed for the sake of clarity that the user equipment is registered in the CSCF and that the call is routed to that CSCF. In other words, the CSCF in which the user equipment is registered controls the call establishment of user equipment. It is irrelevant to the invention how the CSCF is selected during the registration and also how the different CSCF addresses are found out.

For the sake of clarity, it is also assumed that the user of the user equipment uses numbers and prefixes according to the numbering plans. In other words, it is assumed that the telephone number is valid and does not, for example, contain a minus sign as a prefix. It is also assumed that no call barrings have been set.

With reference to FIG. 2, in step 201 a telephone number is received, to which the user of the user equipment wants to call. In step 202 it is checked whether the telephone number contains a prefix ++. If it does, a home numbering plan is used (step 203).

If the telephone number did not have the prefix ++(step 202), it is checked in step 204, whether it has a prefix +. If it does, it deals with an international numbering plan (step 205) which is used for call routing.

If the call has no prefix (i.e. it does not have the prefix ++ nor the prefix +), a serving network numbering plan is used (step 206).

In a second preferred embodiment of the invention, the CSCF checks after step 201, whether the subscriber calls from the home network. If he does, the call is routed according to the prior art on the basis of the telephone number. If the subscriber calls from the visited network, it is continued from step 202 in FIG. 2.

The invention is described in FIG. 2, assuming for the sake of clarity that the number to be transmitted from the user equipment to the network may contain prefixes in text format, such as prefixes ++, which is possible when using Internet type addresses. However, this is not the case for example in the GSM system. In the GSM system, the user equipment identifies the prefix (++, +or no prefix) given by the user and associates the call establishment request with an indicator TON (type of number) as a prefix, the TON indicating, what kind of a number it deals with. Thus, a new type of a telephone number TON has to be defined in these systems, indicating that the home numbering plan is now used.

FIGS. 3 and 4 illustrate the operation according to the third preferred embodiment of the invention, whereby the number sent to the network always contains the prefix TON which indicates what kind of a number is used. The same assumptions are made in FIGS. 3 and 4 as in FIG. 2. In addition, it is assumed for the sake of clarity that only three different prefixes TON are used. It is obvious to a person skilled in the art how the invention is applied if there are more different prefixes.

FIG. 3 illustrates the user equipment operation in the third preferred embodiment of the invention. In step 301 a telephone number is received, to which number the user of the user equipment wants to call. It is checked in step 302, whether the telephone number contains the prefix ++. If it contained the prefix ++, the user wants to use the home numbering plan. As the type of a telephone number TON, “home” is selected in step 303 and the type of the telephone number and the actual telephone number are transmitted to the network in step 307. In step 307, the telephone number to be transmitted always comprises the prefix TON and the actual number.

If the telephone number contained no prefix ++ (step 302), it is checked in step 304 whether it has the prefix +. If it does, the user wants to use the international numbering plan, and in step 305, “international (int)” is selected as the type of the telephone number. Thereafter, the type of the telephone number TON and the actual telephone number are transmitted to the network in step 307.

If the call does not contain a prefix (i.e. it does not contain the prefix ++ nor the prefix +), the user wants to use the serving network numbering plan. In step 306, “local” is selected as the type of the telephone number and the type of the telephone number and the actual telephone number are transmitted to the network in step 307. In some other preferred embodiment of the invention, the serving network numbering plan can also be indicated by some other type of TON.

In the fourth preferred embodiment of the invention, the user equipment is adapted to always set “home” (TON=home) as the type of the telephone number chosen by the user, unless the user indicates something else with his choice. For instance, using the user equipment settings, it can be selected whether the home numbering is on or off. In this case, the user equipment checks the value of this setting before step 302, and if the home numbering is off, it is continued from step 302. If the home numbering is on, the user equipment checks whether the user has given an international number (step 304) and if he has not, the user equipment marks “home” as the type of the telephone number. In other words, in the fourth preferred embodiment of the invention the home numbering plan is used by default unless the subscriber indicates another numbering plan with his selection.

FIG. 4 shows CSCF operation in the third preferred embodiment of the invention. In step 401, both the TON indicating the type of the telephone number and the actual number to which the user of the user equipment wants to call are received. It is checked in step 402 whether the type of the telephone number is “home”. If it is, the home numbering plan is used (step 403).

If the telephone number was not of the type “home” (step 402), it is checked in step 404 whether it is of the type “international”. If it is, it deals with the international numbering plan (step 405), which is used for routing the call.

If the telephone number was not of the type “home” nor of the type “international”, it is “local”, in which case the serving network numbering plan is used (step 406).

In the above embodiments it is assumed that if the user calls from the visited network area, the serving network numbering plan is the numbering plan of the visited network. If the user calls from the home network area, the serving network numbering plan is the home numbering plan in the first, second, third or fourth preferred embodiment of the invention.

In a preferred embodiment of the invention, when calling from the home network, the serving network numbering plan is the home network numbering plan, i.e. then the subscriber's own numbering plan will not be used.

User Equipment Registered in the Home Network CSCF

If the user equipment always registers in the home network CSCF, the user equipment that registers in the visited network area must during the registration, for instance, transmit the visited network CSCF address to the home network CSCF, since, when making a local call in the visited network, the call signalling must finally be routed to the CSCF that is aware of the visited network numbering.

The home network CSCF controls the call when the home numbering plan is used (for example step 203 and step 206, when calling from the home network area in the first embodiment of the invention) or when the home network numbering plan is used (for example step 206, when calling from the home network area in the second embodiment of the invention).

If the visited network numbering plan is used (for example step 206, when calling from the visited network area), the home network CSCF routes the call to the visited network CSCF and it may also transfer the call control to the visited network. Alternatively, the home network CSCF itself can control the call, although the visited network CSCF is responsible for the routing.

When using the international numbering plan, the home network CSCF either controls the call and takes care of the routing itself or it alternatively transfers the control (and the routing) to the visited network CSCF. Both CSCFs can perform the routing by using the international numbering plan.

Alarm calls made from the visited network and/or free calls of the visited network may use the above route or they can be identified by the user equipment as special calls, in which case the call establishment procedure triggered by them differs from what is shown in FIGS. 2, 3 and 4, and the calls are always routed directly to the visited network CSCF. The user equipment can, for example, receive from the SLS the free numbers and alarm numbers of the visited network to identify the calls as special calls.

User Equipment Registered in the Visited Network CSCF

The visited network CSCF controls the call when the visited network numbering plan is used (for example step 206).

If the home numbering plan is used (for example step 203), the visited network CSCF may route the call to the home network CSCF and it may even transfer the call control to the home network. The visited network CSCF receives the home network CSCF address, for example, from the user equipment UE by concluding it on the basis of the identifier of the subscriber using the user equipment or by requesting it from the HSS. Alternatively, the visited network CSCF can control the call itself and request from the home network in each call, for example, where the call should be routed. It is also possible that the entire home numbering plan of the subscriber is transferred to the visited CSCF from the HSS, for example, and the visited CSCF uses it in cases where the user of the user equipment has dialled the prefix ++ in front of the telephone number (whereby, depending on the embodiment, the CSCF receives either the prefix ++ or the prefix TON=home).

When the international numbering plan is used, the visited network CSCF either controls the call and takes care of the call routing itself or it alternatively transfers the control (and the routing) to the home network CSCF.

Although the invention is described above assuming that a prefix indicates that a home numbering plan is used, it is obvious to a person skilled in the art that the invention can also be applied to solutions, in which the prefix indicates that a serving network numbering plan is used and that calls without a prefix are routed according to the home numbering plan.

By means of the prefix, the user of the user equipment can also select, whether a call is controlled by a serving network call control node or a home network call control node. In these embodiments the call control is transferred, if necessary, to the node of the network that the user has indicated by the prefix.

Although the invention is described above assuming that an indicator is a prefix, it is obvious to a person skilled in the art that the invention can also be applied to solutions in which the indicator is given after a telephone number or in which, at least in information sent to a network, the indicator is the message, in which the telephone number is transmitted.

It is to be understood that the above description and the related figures are only intended to illustrate the present invention. Different variations and modifications of the invention will be obvious to a person skilled in the art without deviating from the scope and spirit of the invention disclosed in the attached claims.

1. A method of selecting a numbering plan to be used in routing a call of a subscriber in a telecommunication system, in which at least a home numbering plan defined in the subscriber's home network and a serving network numbering plan are used;
characterized by the method comprising the following steps:
defining a first indicator, by which it is indicated that the home numbering plan defined in the subscriber's home network is used in the call;
receiving from the subscriber a telephone number associated with a call establishment request;
in response to a telephone number with the first indicator, using the home numbering plan to route the call; and
in response to a telephone number without an indicator, using the numbering plan of the network serving the subscriber to route the call.

2. A method of selecting a numbering plan to be used in routing a call of a subscriber in a telecommunication system, in which at least a home numbering plan defined at least in the subscriber's home network and a serving network numbering plan are used;
characterized by the method comprising the following steps:
defining a first indicator, by which it is indicated that the numbering plan of the network serving the subscriber is used in the call;
receiving from the subscriber a telephone number associated with a call establishment request;
in response to a telephone number with the first indicator, using the serving network numbering plan to route the call; and
in response to a telephone number without an indicator, using the home numbering plan defined in the subscriber's home network to route the call.

3. A method as claimed in claim 1 or 2, characterized by
receiving the call establishment request in user equipment;
selecting the numbering plan to be used in the user equipment; and
in response to the home numbering plan, associating in the user equipment the call establishment request to be transmitted to the network with a second indicator which indicates to the network that the call is to be routed according to the home numbering plan; and
in response to the serving network numbering plan, associating in the user equipment the call establishment request to be transmitted to the network with a third indicator which indicates to the network that the call is to be routed according to the serving network numbering plan.

4. A method as claimed in claim 1, 2 or 3, characterized by the serving network numbering plan being the home numbering plan, if the serving network is the home network.

5. A method as claimed in claim 1, 2 or 3, characterized by the serving network numbering plan being the home network numbering plan, if the serving network is the home network.

6. A method as claimed in any one of the preceding claims, characterized by the first indicator being a prefix.

7. A telecommunication system (1) comprising:
at least one unit of user equipment (UE) of a subscriber,
the subscriber's home network (HN) comprising at least one network node (CSCF_H) arranged to route calls, and
at least one visited network (VN) serving the subscriber, comprising
at least one network node (CSCF_V) arranged to route calls,
in which telecommunication system (1) at least a home numbering plan defined in the subscriber's home network and a serving network numbering plan are used,
characterized in that the system (1) is arranged to
check whether a telephone number received by the user equipment from the subscriber contains an indicator;
identify a first indicator, by which it is indicated that the home numbering plan defined in the subscriber's home network is used when routing a call;
in response to the first indicator, use the home numbering plan defined in the subscriber's home network to route the call; and
in response to a telephone number without an indicator, use the numbering plan of the network serving the subscriber to route the call.

8. A telecommunication system (1) comprising:
at least one unit of user equipment (UE) of a subscriber,
the subscriber's home network (HN) comprising at least one network node (CSCF_H) arranged to route calls, and
at least one visited network (VN) serving the subscriber, comprising at least one network node (CSCF_V) arranged to route calls,
in which telecommunication system (1) at least a home numbering plan defined in the subscriber's home network and a serving network numbering plan are used,
characterized in that the system (1) is arranged to
check whether a telephone number received by the user equipment (UE) from the subscriber contains an indicator;
identify a first indicator, by which it is indicated that the numbering plan of the network serving the subscriber is used when routing a call;
in response to the first indicator, route the call by using the numbering plan of the network serving the subscriber; and
in response to a telephone number without an indicator, route the call by using the home numbering plan defined in the subscriber's home network.

9. A system as claimed in claim 6 or 7, characterized in that the user equipment is arranged to perform said checking and identifying and in response to the use of the home numbering plan, to associate a telephone number to be transmitted to the network with a second indicator, which indicates that the home numbering plan is used, and in response to the use of the serving network numbering plan, to associate a telephone number to be transmitted to the network with a third indicator, which indicates that the serving network numbering plan is used.

10. A system as claimed in claim 9, characterized in that the subscriber is registered in a network node (CSCF_H) of the home network (HN), and
the network node (CSCF_H) of the home network is arranged to identify the second and the third indicator, and in response to the call routing by using the serving network numbering plan, to route the call further to a network node (CSCF_V) of the visited network serving the subscriber, which node is responsible for call routing.

11. A system as claimed in claim 9, characterized in that
the subscriber is registered in the network node (CSCF_V) of the visited network (VN), and
the network node (CSCF_V) of the visited network is arranged to identify the second and the third indicator, and in response to the call routing by using the home numbering plan, to route the call further to the network node (CSCF_H) of the subscriber's home network, which node is responsible for call routing.

12. A system as claimed in claim 9, characterized in that
the subscriber is registered in the network node (CSCF V) of the visited network (VN), and
the network node (CSCF_V) of the visited network is arranged to identify the second and the third indicator, and in response to the call routing by using the home numbering plan, to find out routing instructions from the home numbering plan.

13. A system as claimed in claim 7 or 8, characterized in that
the subscriber is registered in the network node (CSCF_H) of the home network (HN) and
the network node (CSCF_H) of the home network is arranged to perform said checking and identifying, and in response to the call routing by using the serving network numbering plan, to route the call further to the network node (CSCF_V) of the visited network serving the subscriber, which node is responsible for call routing.

14. A system as claimed in claim 7 or 8, characterized in that
the subscriber is registered in the network node (CSCF_V) of the visited network (VN), and
the network node (CSCF_V) of the visited network is arranged to perform said checking and identifying and in response to the call routing by using the home numbering plan, to route the call further to the network node (CSCF_H) of the subscriber's home network, which node is responsible for call routing.

15. A system as claimed in claim 7 or 8, characterized in that
the subscriber is registered in the network node (CSCF_V) of the visited network (VN), and
the network node (CSCF_V) of the visited network is arranged to perform said checking and identifying and in response to the call routing by using the home numbering plan, to find out routing instructions from the home numbering plan.

16. A network node which is arranged to route a call of a subscriber in a telecommunication system, in which at least a home numbering plan defined in the subscriber's home network and a serving network numbering plan are used and in which telecommunication system a telephone number to be transmitted to the network contains an indicator, by which the type of a telephone number is indicated, characterized in that the network node (CSCF_V, CSCF_H) is arranged to
identify a first indicator, by which it is indicated that the home numbering plan defined in the subscriber's home network is used in the call; and
in response to the first indicator, route the call by using the home numbering plan defined in the subscriber's home network.

17. A network node which is arranged to route a call of a subscriber in a telecommunication system, in which at least a home numbering plan defined in the subscriber's home network and a serving network numbering plan are used, characterized in that the network node (CSCF_V, CSCF_H) is arranged to
check whether a telephone number associated with a call establishment request contains an indicator;
identify a first indicator, by which it is indicated that the home numbering plan defined in the subscriber's home network is used in the call;
in response to the first indicator, route the call by using the home numbering plan defined in the subscriber's home network; and
in response to a telephone number without an indicator, route the call by using the numbering plan of the network serving the subscriber.

18. A network node which is arranged to route a call of a subscriber in a telecommunication system, in which at least a home numbering plan defined in the subscriber's home network and a serving network numbering plan are used, characterized in that the network node (CSCF_V, CSCF_H) is arranged to
check whether a telephone number associated with a call establishment request contains an indicator;
identify a first indicator, by which it is indicated that the numbering plan of the network serving the subscriber is used in the call;
in response to the first indicator, route the call by using the numbering plan of the network serving the subscriber; and
in response to a telephone number without an indicator, route the call by using the home numbering plan defined in the subscriber's home network.

19. User equipment (UE), which is arranged to forward a telephone number associated with a call establishment request of a subscriber using the user equipment in a telecommunication system, in which at least a home numbering plan defined in the subscriber's home network and a serving network numbering plan are used, which telephone number to be transmitted to the network contains a type indicator, by which the type of the telephone number is indicated,
characterized in that the user equipment (UE) is arranged to
check whether the telephone number associated with the call establishment request contains an indicator;
identify a first indicator, by which it is indicated that the home numbering plan defined in the subscriber's home network is used when routing a call;
in response to the first indicator, associate the telephone number to be transmitted to the network with a first type indicator which indicates to the network that the call is routed by using the home numbering plan defined in the subscriber's home network; and
in response to the telephone number without an indicator, associate the telephone number to be transmitted to the network with a second type indicator which indicates to the network that the call is routed by using the numbering plan of the network serving the subscriber.

20. User equipment (UE), which is arranged to forward a telephone number associated with a call establishment request of a subscriber using the user equipment in a telecommunication system, in which at least a home numbering plan defined in the subscriber's home network and a serving network numbering plan are used, which telephone number to be transmitted to the network contains a type indicator, by which the type of the telephone number is indicated,
characterized in that the user equipment (UE) is arranged to
check whether the telephone number associated with the call establishment request contains an indicator;
identify a first indicator, by which it is indicated that the numbering plan of the network serving the subscriber is used when routing a call;
in response to the first indicator, associate the telephone number to be transmitted to the network with a first type indicator which indicates to the network that the call is routed by using the numbering plan of the network serving the subscriber; and
in response to the telephone number without an indicator, associate the telephone number to be transmitted to the network with a second type indicator which indicates to the network that the call is routed by using the home numbering plan defined in the subscriber's home network.

21. User equipment (UE), which is arranged to forward a telephone number associated with a call establishment request of a subscriber using the user equipment in a telecommunication system, in which at least a home numbering plan defined in the subscriber's home network and a serving network numbering plan are used, which telephone number to be transmitted to the network contains an indicator, by which the type of the telephone number is indicated,
characterized in that the user equipment (UE) is arranged to
maintain information in its settings, whether the home numbering plan is used by default;
check whether the telephone number associated with the call establishment request uses the numbering plan by default; and
if the numbering plan by default is the home numbering plan, in response to the use of the numbering plan by default, associate the telephone number to be transmitted to the network with an indicator, which indicates that the call is routed by using the home numbering plan defined in the subscriber's home network.
